(19) United States
(12) Patent Application Publication
(10) Pub. No.: US 2020/0014015 A1
(43) Pub. Date: Jan. 9, 2020

(54) BATTERY CELL AND BATTERY HAVING BATTERY CELL THEREIN

(71) Applicant: NINGDE AMPEREX TECHNOLOGY LIMITED, Ningde (CN)

(72) Inventors: Qiang TAO, Ningde (CN); Shuai LI, Ningde (CN); Qi DANG, Ningde (CN); Qiang ZHENG, Ningde (CN); Zhanzhao FANG, Ningde (CN); Shixi YU, Ningde (CN)

(21) Appl. No.: 16/454,863

(22) Filed: Jun. 27, 2019

(30) Foreign Application Priority Data
Jul. 3, 2018 (CN) 201810718285.0

(51) Int. Cl. H01M 2/26; H01M 10/0587; H01M 10/04; H01M 10/0525; H01M 4/70; H01M 4/36; H01M 4/04; H01M 2/34

(52) U.S. Cl. CPC H01M 2/263; H01M 10/0587; H01M 10/0431; H01M 2/34; H01M 4/70; H01M 4/366; H01M 4/0404; H01M 10/0525

(57) ABSTRACT

An electrode assembly and a battery are disclosed. The electrode assembly includes a first current collector including a first section and a second section, a second current collector including a third section and a fourth section, and a first protective layer. An outer surface of the first section is provided with an active material layer, and none of an outer surface and an inner surface of the second section, an inner surface of the first section, an outer surface of the third section, and an inner surface of the fourth section is provided with the active material layer. The outer surface of the third section faces the inner surface of the first section and the inner surface of the second section, and the inner surface of the fourth section faces the outer surface of the second section.

### FIELD

The present disclosure relates to a technical field of electrochemical devices, and more particularly relates to an electrode assembly and a battery.

### BACKGROUND

For polymer lithium-ion batteries, high energy density are constantly pursued, which is followed by a huge challenge to safety. Many high-energy-density electrode assemblies face a risk of failing in some safety tests, such as nail penetration tests. A common method for improving nail penetration is implemented by means of a cathode current collector and an anode current collector, neither of which are provided with an active material on both sides. However, such cathode and anode current collectors have certain drawbacks. First, the cathode and anode current collectors are prone to sliding during winding, resulting in mutual contact between the current collectors, and causing a short-circuit risk in subsequent charge and discharge processes. Second, as for the above cathode and anode current collectors at an outer side, in a case of relative displacement between an electrode assembly and an aluminum plastic film, if the electrode assembly drops, a double-faced adhesive tape at a tail end will tear the current collectors, thereby leading to a short-circuit risk. Additionally, for the above cathode and anode current collectors at an inner side, a nail generally can penetrate only a few superficial layers of the electrode assembly and cannot reach the cathode and anode current collectors in actual working conditions, thereby resulting in malfunction of the nail penetration test.

### SUMMARY

The present disclosure aims to solve at least one of the problems existing in the related art. For this purpose, the present disclosure provides an electrode assembly that has advantages of a simple structure and good performance.

The present disclosure further provides a battery that includes the above electrode assembly.

According to embodiments of the present disclosure, an electrode assembly includes a first current collector, a second current collector, and a first protective layer. The first current collector and the second current collector are wound to form the electrode assembly. The first current collector includes a first section and a second section connected to the first section, an outer surface of the first section is provided with an active material layer, and none of an outer surface of the second section, an inner surface of the second section, and an inner surface of the first section is provided with the active material layer. The second current collector includes a third section and a fourth section, the third section is located at an inner side of the first section, the fourth section is located at an outer side of the second section, and neither of an outer surface of the third section and an inner surface of the fourth section is provided with the active material layer. The outer surface of the third section faces the inner surface of the first section and the inner surface of the second section, and the inner surface of the fourth section faces the outer surface of the second section. The first protective layer is provided on the inner surface of the fourth section.

For the electrode assembly according to the embodiments of the present disclosure, since the inner surface of the fourth section is provided with the first protective layer, and the outer surface of the second section facing the inner surface of the fourth section is not provided with the active material layer, this structure can quickly release the energy of the electrode assembly by means of a short circuit between the first current collector and the second current collector in a nail penetration test, thereby avoiding ignition and failure of the electrode assembly. Additionally, by controlling the length of the active material layer provided on opposite surfaces of the first current collector and the second current collector, it is also possible to effectively avoid the short circuit caused by the sliding of the current collector for lack of the active material on both sides during the winding.

In some embodiments of the present disclosure, the first section includes a first arc segment and a first straight segment connected to the first arc segment, and the second section includes a second arc segment connected with the first straight segment.

In some embodiments of the present disclosure, the third section includes a third arc segment, a second straight segment, and a fourth arc segment connected sequentially; and the fourth section includes a fifth arc segment, and the fifth arc segment is not connected with the fourth arc segment.

In some embodiments of the present disclosure, the second current collector includes a fifth section, and the fifth section connects the fifth arc segment with the fourth arc segment.

In some embodiments of the present disclosure, the electrode assembly includes a second protective layer, and the second protective layer is provided on the outer surface of the third section.

In some embodiments of the present disclosure, the second protective layer is provided on an outer surface of the third arc segment.

In some embodiments of the present disclosure, the first current collector is configured as an anode current collector, and the second current collector is configured as a cathode current collector.

In some embodiments of the present disclosure, the first current collector is configured as a copper foil, and the second current collector is configured as an aluminum foil.

According to embodiments of the present disclosure, a battery includes a packaging case; an electrode assembly which is the electrode assembly as described above and located in the packaging case; a first tab electrically connected with the first current collector; and a second tab electrically connected with the second current collector. The first tab and the second tab extend through the packaging case.

For the battery according to the embodiments of the present disclosure, since the inner surface of the fourth section is provided with the first protective layer, and the outer surface of the second section facing the inner surface of the fourth section is not provided with the active material layer, this structure can quickly release the energy of the electrode assembly by means of a short circuit between the first current collector and the second current collector in a nail penetration test, thereby avoiding ignition and failure of the electrode assembly. Additionally, by controlling the length of the active material layer provided on opposite surfaces of the first current collector and the second current collector, it is also possible to effectively avoid the short circuit caused by the sliding of the current collector for lack of the active material on both sides during the winding.

In some embodiments of the present disclosure, the packaging case includes a first side and a second side, and the first side and the second side are opposite sides of the packaging case in a direction perpendicular to the first tab, the first tab is more adjacent to the second side than the first side, and the first straight segment is more adjacent to the first side than the second side.

### BRIEF DESCRIPTION OF THE DRAWINGS

The above and/or additional aspects and advantages of the present disclosure will become apparent and more readily appreciated from the following descriptions about embodiments with reference to the drawings, in which:

FIG. 1 illustrates a schematic view of a battery in accordance with an embodiment of the present disclosure.

FIG. 2 illustrates a schematic view of an electrode assembly in accordance with an embodiment of the present disclosure.

FIG. 3 illustrates a schematic view of a winding first current collector of an electrode assembly in accordance with an embodiment of the present disclosure.

FIG. 4 illustrates a schematic view of a partially winding first current collector of an electrode assembly in accordance with an embodiment of the present disclosure.

FIG. 5 illustrates a schematic view of an unwinding first current collector of an electrode assembly in accordance with an embodiment of the present disclosure, in which arrow “a” indicates a winding direction.

FIG. 6 illustrates a schematic view of a winding second current collector of an electrode assembly in accordance with an embodiment of the present disclosure.

FIG. 7 illustrates a schematic view of a partially winding second current collector of an electrode assembly in accordance with an embodiment of the present disclosure.

FIG. 8 illustrates a schematic view of an unwinding second current collector of an electrode assembly in accordance with an embodiment of the present disclosure, in which arrow “a” indicates a winding direction.

FIG. 9 illustrates a schematic view of a packaging case for an electrode assembly in accordance with an embodiment of the present disclosure.

### REFERENCE NUMERALS

electrode assembly 100, active material layer 101,

first current collector 110,
first section 111, first arc segment 1111, first straight segment 1112,
second section 112, second arc segment 1121,

second current collector 120,
third section 121, third arc segment 1211, second straight segment 1212, fourth arc segment 1213,
fourth section 122, fifth arc segment 1221,
fifth section 123,

first protective layer 130,

second protective layer 140,

battery 200, first tab 201, second tab 202,

packaging case 210, first side (deeply recessed side) 211, second side (shallowly recessed side) 212.

### DETAILED DESCRIPTION

Embodiments of the present disclosure will be described in detail and examples of the embodiments will be illustrated in the drawings, where same or similar reference numerals are used to indicate same or similar members or members with same or similar functions. The embodiments described herein with reference to drawings are explanatory, illustrative, and used to generally understand the present disclosure. The embodiments shall not be construed to limit the present disclosure.

In the specification, it is to be understood that terms such as “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential” and the like should be construed to refer to the orientation or position relationship as then described or as shown in the drawings under discussion. These relative terms are only for convenience and simplicity of description and do not indicate or imply that the referred device or element must have a particular orientation or be constructed or operated in a particular orientation. Thus, these terms shall not be construed to limit the present application. In addition, the feature defined with the term “first” and “second” may explicitly or implicitly comprise one or more of this feature. In the description of the present disclosure, the term “a plurality of” means two or more than two, unless specified otherwise.

In the description of the present disclosure, unless specified or limited otherwise, the terms “mounted,” “connected,” “coupled” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

An electrode assembly 100 and a battery 200 according to embodiments of the present disclosure will be described in detail with reference to drawings. It should be noted that the battery 200 may include all kinds of primary batteries, secondary batteries, fuel batteries, solar batteries, and capacitors, such as supercapacitors. Particularly preferred are lithium secondary batteries, including lithium metal secondary batteries, lithium-ion secondary batteries, lithium polymer secondary batteries, and lithium-ion polymer secondary batteries.

In general, a lithium-ion secondary battery can include a lithium-based oxide as a positive active material constituting a cathode and a carbon material as a negative active material constituting an anode. The cathode and the anode are separated from each other by a separator (typically a polymeric microporous membrane) that allows lithium ions to be exchanged between the two electrodes and prevents electrons from being exchanged. In the light of an electrolyte for a lithium-ion secondary battery, a lithium-ion battery is further classified into a liquid-electrolyte battery and a polyelectrolyte battery. For example, a secondary battery using a liquid electrolyte is called “a lithium-ion secondary battery” while a secondary battery using a polyelectrolyte is called “a lithium polymer secondary battery”. The lithium-ion secondary battery may be formed into various shapes, such as a can-type lithium-ion secondary battery and a bag-type lithium-ion secondary battery.

Typically, the electrode assembly 100 is assembled in a discharged state because a cathode material (for example, LiCoO₂, LiFePO₄) and an anode material (for example, carbon) are stable in the air after discharging, and thus are easy to deal with in industrial practice. During charging, the two electrodes are coupled to a power supply outside the battery, such that electrons are released from the cathode to the anode. Meanwhile, inside the battery, lithium ions migrate from the cathode to the anode via the electrolyte. In this way, external energy is electrochemically stored in the form of chemical energy in the anode material and cathode material with different chemical potential energies (i.e., the cathode has a high potential while the anode has a low potential). During discharging, outside the battery, electrons migrate from the anode to the cathode for operation via an external load (such as a circuit in a mobile phone or a motor in an electric vehicle). While inside the battery, lithium ions migrate from the anode to the cathode in the electrolyte. As a result, an electrochemical reaction at these two electrodes makes the stored chemical energy release. This is also called a “shuttle chair” mechanism, by which lithium ions shuttle between the anode and the cathode during the charging and discharging cyclic processes.

Various parameters can be adopted to monitor the performance of lithium-ion batteries, such as specific energy, volumetric energy, specific capacity, cycle performance, safety, abuse resistance, and charge and discharge rates. For example, the specific energy (Wh/kg) is used to measure the amount of energy that can be stored and released per unit mass of the battery, and the specific energy (Wh/kg) can be determined by multiplying the specific capacity (Ah/kg) by an operating voltage (V) of the battery. The specific capacity is used to measure the amount of charge that can be reversibly stored per unit mass of the battery, and the specific capacity is closely related to the number of electrons released by the electrochemical reaction and the atomic mass of a subject. The cycle performance is used to measure the reversibility of lithium ions during intercalation and escape processes, based on the number of charge and discharge cycles before the battery significantly loses energy or is no longer able to maintain the function of its energized device.

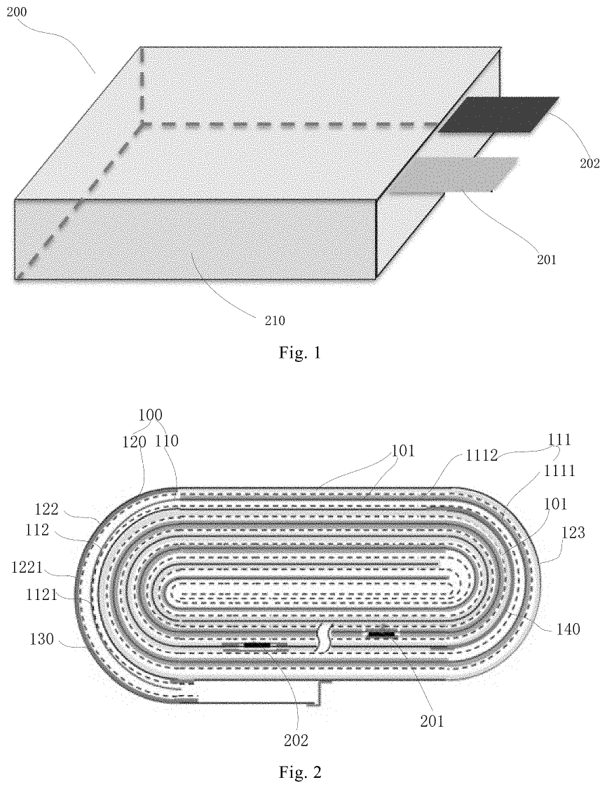

As illustrated in FIG. 1, the electrode assembly 100 according to embodiments of the present disclosure includes a first current collector 110, a second current collector 120 and a first protective layer 130 laminated on each other, in which the first current collector 110 and the second current collector 120 are wound to form the electrode assembly 100. The first protective layer 130 may be a viscous material layer and can adhere to a surface of the first current collector 110 and/or the second current collector 120.

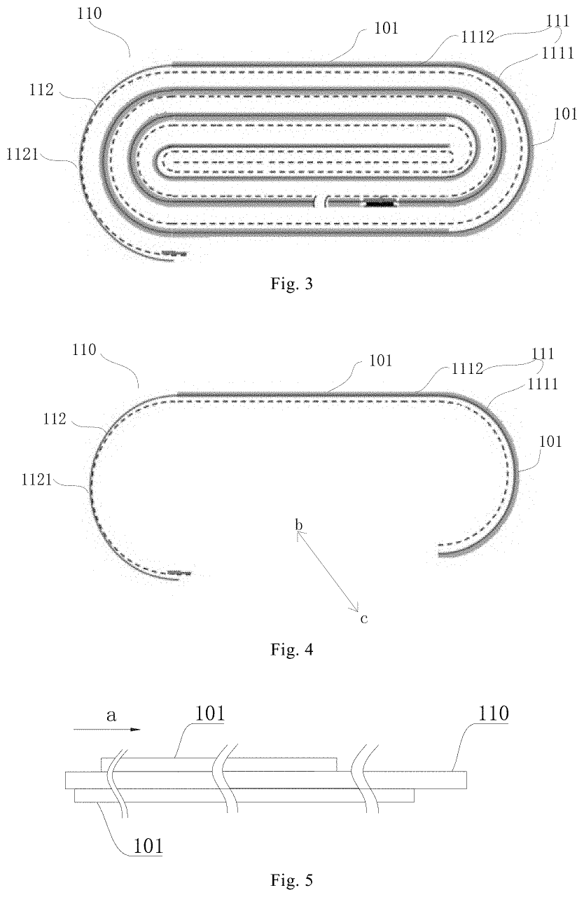

As illustrated in FIGS. 3, 4 and 5, the first current collector 110 can include a first section 111 and a second section 112 connected to the first section 111. An outer surface (a surface in a “c” direction as shown in FIG. 4) of the first section 111 is provided with an active material layer 101, but an outer surface (a surface in the “c” direction as shown in FIG. 4) of the second section 112, an inner surface (a surface in a “b” direction as shown in FIG. 4) of the second section 112, and an inner surface (a surface in the “b” direction as shown in FIG. 4) of the first section 111 are not provided with the active material layer 101.

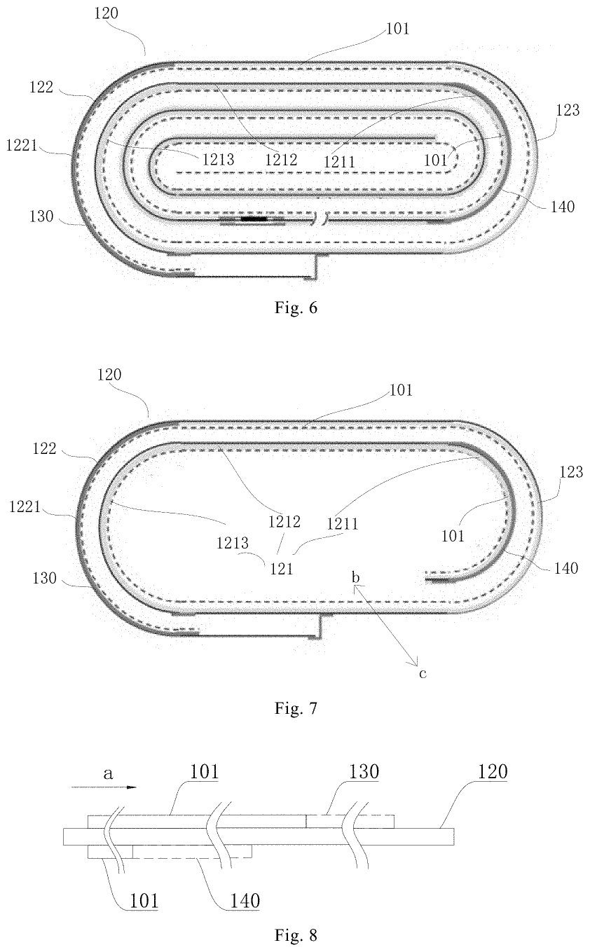

As illustrated in FIGS. 6, 7 and 8, the second current collector 120 can include a third section 121 and a fourth section 122.

The third section 121 is located at an inner side of the first section 111 (in the “b” direction as shown in FIGS. 4 and 7), and the fourth section 122 is located at an outer side of the second section 112 (in the “c” direction as shown in FIGS. 4 and 7). An outer surface (a surface in the “c” direction as shown in FIG. 7) of the third section 121 and an inner surface (a surface in the “b” direction as shown in FIG. 7) of the fourth section are not provided with the active material layer 101. The outer surface (a surface in the “c” direction as shown in FIG. 7) of the third section 121 faces the inner surface (the surface in the “b” direction as shown in FIG. 4) of the first section 111 and the inner surface (the surface in the “b” direction as shown in FIG. 4) of the second section 112. The inner surface (the surface in the “b” direction as shown in FIG. 7) of the fourth section 122 faces the outer surface (the surface in the “c” direction as shown in FIG. 4) of the second section 112.

As illustrated in FIG. 7, the first protective layer 130 is located at the inner surface of the fourth section 122, that is, the inner surface (the surface in the “b” direction as shown in FIG. 7) of the fourth section 122 is provided with the first protective layer 130, such that the electrode assembly 100 can be prevented from sliding during winding due to current collectors without the active material on both sides.

For the electrode assembly 100 according to embodiments of the present disclosure, since the inner surface (the surface in the “b” direction as shown in FIG. 7) of the fourth section 122 is provided with the first protective layer 130, and the outer surface (the surface in the “c” direction as shown in FIG. 4) of the second section 112 facing the inner surface (the surface in the “b” direction as shown in FIG. 7) of the fourth section 122 is not provided with the active material layer 101, this structure can quickly release the energy of the electrode assembly 100 by means of a short circuit between the first current collector 110 and the second current collector 120 in a nail penetration test, thereby avoiding ignition and failure of the electrode assembly 100. Additionally, by controlling the length of the active material layer 101 provided on opposite surfaces of the first current collector 110 and the second current collector 120, it is also possible to effectively avoid the short circuit caused by the sliding of the current collector for lack of the active material on both sides during the winding.

As illustrated in FIGS. 3 and 4, according to some embodiments of the present disclosure, the first section 111 can include a first arc segment 1111 and a first straight segment 1112 connected to the first arc segment 1111. That is, in a winding process of the first section 111, the first section 111 has a partial structure located at a turning portion to constitute the first arc segment 1111, and the first section 111 also has a partial structure located at a straight portion to constitute the first straight segment 1112. The second section 112 can include a second arc segment 1121, and the second arc segment 1121 is connected with the first straight segment 1112. It could be understood that in a winding process of the second section 112, the second section 112 has at least a partial structure located at a turning portion, the turning structure is the second arc segment 1121, and the second arc segment 1121 is connected with the first straight segment 1112 of the first section 111.

As illustrated in FIGS. 6 and 7, the third section 121 can include a third arc segment 1211, a second straight segment 1212, and a fourth arc segment 1213 connected sequentially. For example, as illustrated in FIG. 7, in a winding process of the third section 121, the wound third section 121 includes two turning structures (i.e., the third arc segment 1211 and the fourth arc segment 1213) and one straight structure (i.e., the second straight segment 1212), and the one straight structure is provided between the two turning structures.

Further, as illustrated in FIG. 7, the fourth section 122 can include a fifth arc segment 1221, and the fifth arc segment 1221 is not connected with the fourth arc segment 1213. It could be understood that in a winding process of the fourth section 122, the fourth section 122 has at least a partial structure located at a turning portion to constitute the fifth arc segment 1221, and other partial structures of the second current collector 120 are located between the fifth arc segment 1221 and the fourth arc segment 1213, that is, the fifth arc segment 1221 is indirectly connected with the fourth arc segment 1213.

In some embodiments, as illustrated in FIG. 7, the second current collector 120 can include a fifth section 123, and the fifth section 123 is U-shaped and connected between the fifth arc segment 1221 and the fourth arc segment 1213. According to some embodiments of the present disclosure, as illustrated in FIGS. 6 and 7, the second protective layer 140 is located at the outer surface of the third section 121, that is, the outer surface of the third section 121 is provided with the second protective layer 140, such that the electrode assembly 100 can be prevented from sliding due to current collectors for lack of the active material on both sides during the winding. Further, the second protective layer 140 is located at an outer surface of the third arc segment 1211. The second protective layer 140 may be a viscous material layer and can adhere to the surface of the current collector.

In some embodiments, the outermost circle of the electrode assembly 100 is a current collector provided with the active material in a single side. For instance, in examples shown in FIGS. 2, 6 and 7, a tail portion of the second current collector 120 constitutes the outermost circle of the electrode assembly 100, and the portion of the second current collector 120 in this circle is provided with the active material layer 101 on a single side alone, such that it is possible to avoid a problem that the current collector is torn due to a double-faced adhesive tape when the electrode assembly 100 drops.

According to some embodiments of the present disclosure, the first current collector 110 is an anode current collector, and the second current collector 120 is a cathode current collector. Further, the first current collector 110 is a copper foil, while the second current collector 120 is an aluminum foil. As illustrated in FIGS. 1 and 2, the first current collector 110 can be provided with a first tab 201 at an end thereof, and the second current collector 120 can be provided with a second tab 202 at an end thereof. In a winding process of the electrode assembly 100, the first tab 201 has a first end connected with the first current collector 110 and located inside the electrode assembly 100, and a second end located outside the electrode assembly 100. Likewise, in the winding process of the electrode assembly 100, the second tab 202 has a first end connected with the second current collector 120 and located inside the electrode assembly 100, and a second end located outside the electrode assembly 100.

Major requirements for cathode materials include high free energy for reaction with lithium, doping a large amount of lithium, and insolubility in electrolytes. In certain embodiments, cathode materials can be classified as follows based on the relationship between voltage and lithium: (i) 2-volt cathode materials, such as TiS₂ and MoS₂ with a 2D layered structure; (ii) 3-volt cathode materials, such as MnO₂ and V₂O₅; (iii) 4-volt cathode materials, such as LiCoO₂ and LiNiO₂ with a 2D layered structure, 3D spinel-type LiMn₂O₄ and olivine-type LiFePO₄; and (iv) 5-volt cathode materials, such as olivine-type LiMnPO₄, LiCoPO₄, and Li₂MₓMn4_ₓO₈ (M=at least one of Fe and Co) with a spinel-type 3D structure. It should be noted that although a high cathode voltage is desired because the stored energy is proportional to an operating voltage of the electrode assembly 100, the stability of electrolyte needs to be considered when selecting a high voltage cathode material.

Among the cathode materials described above, LiCoO₂ and LiFePO₄ are the most widely used in commercial lithium-ion batteries because of their good cycle life (>500 cycles). In addition, LiCoO₂ is easy for mass production and stable in air. Compared with LiCoO₂, LiFePO₄-based cathode materials have lower production costs and lower environmental loads. Other advantages offered by LiFePO₄ include stability cycle life, and temperature tolerance (−20° C.-70° C.). Two strategies (i.e., ion doping and carbon coating) have been employed to further enhance electronic conductivity and ionic conductivity of LiFePO₄.

Anode materials can be selected from more candidates than cathode materials. The electrochemical performance of lithium-ion batteries, including cycle performance, charge rate and energy density, can be significantly affected by anode materials. At present, carbon is still a dominant choice in current commercial lithium-ion batteries. For example, graphite carbon with a laminated structure can promote lithium ions to migrate into and out of a lattice space of graphite carbon with minimal irreversibility, achieving excellent cycle performance.

Studies have shown that tin and many other elements (including silicon), which are known to form alloys with lithium, are good candidates for lithium storage in place of carbon. These elements are capable of alloying with lithium and de-alloying electrochemically. However, during the charging/discharging process, the alloying/de-alloying process is achieved by a substantial change in the specific volume of the material. In a number of cycles, the generated high mechanical stress can lead to destruction of a crystal structure and separation of the active material from the current collector, or the so-called “pulverization” phenomenon. The resulting poor cycle performance has significantly limited their applicability in real situations. One way to improve the cycle performance of the anode materials is to introduce a composite. In this type of composite materials, one component (usually carbon) acts as a stress absorber, while other components (such as silicon or tin) provide a significant increase in capacity. In this way, a composite having higher capacity than carbon and having better cycle performance than Sn or Si can be obtained.

Electrochemical characteristics suggest that if TiO₂ is adopted, potential risks of metal lithium deposition and dendritic crystal formation, short circuits, and thermal runaway in carbon-based batteries can be avoided. In addition, no surface electrolyte interphase (SEI) is formed on TiO₂ in its potential window. Therefore, in situations where safety is a top priority, for example, in aeronautics and astronautics applications, TiO₂-based anodes can be found in some niche applications.

Iron oxides have been regarded as an anode material in place of carbon for high-capacity lithium-ion batteries because of its low cost, non-toxicity and environmental friendliness. Carbon coating has been used to improve electrochemical properties of iron oxides. Carbon coating can enhance electrical conductivity of each single unit and improve electrical contact between different units. A carbon layer can also act as a buffer layer to relieve stress due to large volume expansion, avoid structural collapse, or improve cycle performance.

Finally, research has revealed that the size and shape adjustability of those nanoscale lithium active materials can impart additional parameters for further optimization of their electrochemical performance. Nanostructured electrode materials can bring about many advantages which are not available in conventional bulk materials.

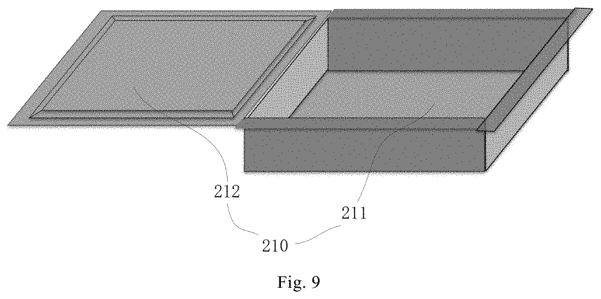

As illustrated in FIGS. 1 and 9, the battery 200 according to embodiments of the present disclosure includes a first tab 201, a second tab 202, a packaging case 210, and an electrode assembly which may be the electrode assembly 100 as described above. The electrode assembly 100 is located within the packaging case 210.

For the battery 200 according to embodiments of the present disclosure, since the inner surface (the surface in the “b” direction as shown in FIG. 7) of the fourth section 122 is provided with the first protective layer 130, and the outer surface (the surface in the “c” direction as shown in FIG. 4) of the second section 112 facing the inner surface (the surface in the “b” direction as shown in FIG. 7) of the fourth section 122 is not provided with the active material layer 101, this structure can quickly release the energy of the electrode assembly 100 by means of a short circuit between the first current collector 110 and the second current collector 120 in a nail penetration test, thereby avoiding ignition and failure of the electrode assembly 100. Additionally, by controlling the length of the active material layer 101 provided on opposite surfaces of the first current collector 110 and the second current collector 120, it is also possible to effectively avoid the short circuit caused by the sliding of the current collector for lack of the active material on both sides during the winding.

In some embodiments, as illustrated in FIG. 9, the packaging case 210 can include a first side 211 (a deeply recessed side) and a second side 212 (shallowly recessed side) opposite to each other, and the first section 111 is located in the deeply recessed side 211. Since an armor area is formed in the next-outermost circle at the deeply recessed side 211 and side walls thereof, the armor area can play a role in the nail penetration.

In some embodiments, as illustrated in FIG. 9, the packaging case 210 can include a first side 211 and a second side 212. The first side 211 and the second side 212 are opposite sides of the packaging case 210 in a direction perpendicular to the first tab 201. The first tab 201 is more adjacent to the second side 212 than the first side 211, and the first straight segment 1112 is more adjacent to the first side 211 than the second side 212.

Reference throughout this specification to “an embodiment,” “some embodiments,” “an illustrative embodiment”, “an example,” “a specific example,” or “some examples,” means that a particular feature, structure, material, or characteristic described in connection with the embodiment or example is included in at least one embodiment or example of the present disclosure. Thus, the above phrases in various places throughout this specification are not necessarily referring to the same embodiment or example of the present disclosure. Furthermore, the particular features, structures, materials, or characteristics may be combined in any suitable manner in one or more embodiments or examples.

Although embodiments of the present disclosure have been shown and illustrated, it would be appreciated by those skilled in the art that changes, modifications, alternatives and variations can be made in the embodiments without departing from the principle and purpose of the present disclosure. The scope of the present disclosure is defined by the claims or the like.

What is claimed is:

1. An electrode assembly, comprising:
a first current collector;
a second current collector, winding together with the first current collector to form the electrode assembly; and
a first protective layer;
wherein the first current collector comprises a first section and a second section connected to the first section, an outer surface of the first section is provided with an active material layer, and none of an outer surface of the second section, an inner surface of the second section, and an inner surface of the first section is provided with the active material layer;
the second current collector comprises a third section and a fourth section, the third section is located at an inner side of the first section, the fourth section is located at an outer side of the second section, and neither of an outer surface of the third section and an inner surface of the fourth section is provided with the active material layer;
the outer surface of the third section faces the inner surface of the first section and the inner surface of the second section, and the inner surface of the fourth section faces the outer surface of the second section; and
the first protective layer is provided on the inner surface of the fourth section.

2. The electrode assembly according to claim 1, wherein the first section comprises a first arc segment and a first straight segment connected to the arc segment, the second section comprises a second arc segment, and the second arc segment is connected with the first straight segment.

3. The electrode assembly according to claim 1, wherein the third section comprises a third arc segment, a second straight segment, and a fourth arc segment connected sequentially, the fourth section comprises a fifth arc segment, and the fifth arc segment is not connected with the fourth arc segment.

4. The electrode assembly according to claim 3, wherein the second current collector comprises a fifth section, and the fifth section connects the fifth arc segment with the fourth arc segment.

5. The electrode assembly according to claim 3, further comprising a second protective layer, wherein the second protective layer is provided on the outer surface of the third section.

6. The electrode assembly according to claim 5, wherein the second protective layer is provided on an outer surface of the third arc segment.

7. The electrode assembly according to claim 1, wherein the first current collector is configured as an anode current collector, and the second current collector is configured as a cathode current collector.

8. The electrode assembly according to claim 1, wherein the first current collector is configured as a copper foil, and the second current collector is configured as an aluminum foil.

9. A battery, comprising:
an electrode assembly comprising:
a first current collector;
a second current collector, winding together with the first current collector to form the electrode assembly; and
a first protective layer;
wherein the first current collector comprises a first section and a second section connected to the first section, an outer surface of the first section is provided with an active material layer, and none of an outer surface of the second section, an inner surface of the second section, and an inner surface of the first section is provided with the active material layer;
the second current collector comprises a third section and a fourth section, the third section is located at an inner side of the first section, the fourth section is located at an outer side of the second section, and neither of an outer surface of the third section and an inner surface of the fourth section is provided with the active material layer;
the outer surface of the third section faces the inner surface of the first section and the inner surface of the second section, and the inner surface of the fourth section faces the outer surface of the second section; and
the first protective layer is provided on the inner surface of the fourth section;
a first tab electrically connected with the first current collector;
a second tab electrically connected with the second current collector; and
a packaging case;
wherein the electrode assembly is arranged in the packaging case, and the first tab and the second tab extend through the packaging case.

10. The battery according to claim 9, wherein the packaging case comprises a first side and a second side, and the first side and the second side are opposite sides of the packaging case in a direction perpendicular to the first tab, the first tab is more adjacent to the second side than the first side, and the first straight segment is more adjacent to the first side than the second side.

11. The battery according to claim 9, wherein the first section comprises a first arc segment and a first straight segment connected to the first arc segment, the second section comprises a second arc segment, and the second arc segment is connected with the first straight segment.

12. The battery according to claim 9, wherein the third section comprises a third arc segment, a second straight segment, and a fourth arc segment connected sequentially, the fourth section comprises a fifth arc segment, and the fifth arc segment is not connected with the fourth arc segment.

13. The battery according to claim 12, wherein the second current collector comprises a fifth section, and the fifth section connects the fifth arc segment with the fourth arc segment.

14. The battery according to claim 12, further comprising a second protective layer, wherein the second protective layer is provided on the outer surface of the third section.

15. The battery according to claim 14, wherein the second protective layer is provided on an outer surface of the third arc segment.

16. The battery according to claim 9, wherein the first current collector is configured as an anode current collector, and the second current collector is configured as a cathode current collector.

17. The battery according to claim 9, wherein the first current collector is configured as a copper foil, and the second current collector is configured as an aluminum foil.
